(19) United States
(12) Patent Application Publication
(10) Pub. No.: US 2024/0196036 A1
(43) Pub. Date: Jun. 13, 2024

(54) ADVERTISEMENT ALLOCATION GENERATION DEVICE, BROADCAST SYSTEM, AND ADVERTISEMENT ALLOCATION GENERATION METHOD

(71) Applicant: NEC Corporation, Minato-ku, Tokyo (JP)

(72) Inventors: Yasubumi HONMA, Tokyo (JP); Fuyuki MATSUURA, Tokyo (JP); Kazuaki SAITO, Tokyo (JP); Nanami TANOUE, Tokyo (JP)

(73) Assignee: NEC Corporation, Minato-ku, Tokyo (JP)

(21) Appl. No.: 18/284,697

(22) PCT Filed: Apr. 8, 2021
(86) PCT No.: PCT/JP2021/014890

§ 371 Date: Sep. 28, 2023

(51) Int. Cl. H04N 21/2668; H04N 21/81

(52) U.S. Cl. CPC H04N 21/2668; H04N 21/812

(57) ABSTRACT

An advertisement allocation generation device of the present disclosure includes viewing data acquiring means, advertisement allocation condition acquiring means, and advertisement allocating means. The viewing data acquiring means acquires viewing-related data of a viewer from a terminal device with which the viewer views content. The advertisement allocation condition acquiring means acquires advertisement allocation condition data for allocating an advertisement to a program. The advertisement allocating means generates, based on the viewing-related data and the advertisement allocation condition data, advertisement allocation information obtained by allocating the advertisement to content to be broadcast to the viewer.

### TECHNICAL FIELD

The present invention relates to an advertisement allocation generation device, a broadcast system, an advertisement allocation generation method, and a non-transitory computer-readable medium.

### BACKGROUND ART

In a commercial broadcast system, an experienced veteran or an expert allocates advertisements to advertisement frames. Therefore, it is difficult for an inexperienced person in charge or a non-expert to appropriately allocate advertisements.

Patent Literature 1 discloses a technique for distributing program content into which an advertisement suitable for a viewer is inserted based on preference information of the viewer.

Patent Literature 2 discloses a technique for distributing streaming content into which an advertisement suitable for a viewer is inserted based on preference information of the viewer.

### CITATION LIST

### Patent Literature

Patent Literature 1: Japanese Unexamined Patent Application Publication No. 2003-179901

Patent Literature 2: Japanese Unexamined Patent Application Publication No. 2004-364001

### SUMMARY OF INVENTION

### Technical Problem

However, in Patent Literature 1 and Patent Literature 2, there is a problem in that the advertisement to be inserted into the content to be broadcast to the viewer can be selected only using the preference information of the viewer and, for example, requirements of a sponsor, who is a provider of the advertisement, cannot be reflected on the advertisement to be inserted.

In view of such a problem, an object of the present disclosure is to provide an advertisement allocation generation device, a broadcast system, an advertisement allocation generation method, and a non-transitory computer-readable medium capable of inserting an advertisement reflecting, for example, requirements of a sponsor into content.

### Solution to Problem

An advertisement allocation generation device of the present disclosure includes: viewing data acquiring means for acquiring viewing-related data of a viewer from a terminal device with which the viewer views content; advertisement allocation condition acquiring means for acquiring advertisement allocation condition data for allocating advertisement content to a program; and advertisement allocating means for generating, based on the viewing-related data and the advertisement allocation condition data, advertisement allocation information obtained by allocating advertisement content to content to be broadcast to the viewer.

A broadcast system of the present disclosure includes: viewing-related data acquiring means for acquiring viewing-related data of a viewer from a terminal device with which the viewer views content; advertisement allocation condition acquiring means for acquiring advertisement allocation condition data for allocating advertisement content to a program; and advertisement allocating means for generating, based on the viewing-related data and the advertisement allocation condition data, advertisement allocation information obtained by allocating advertisement content to content to be broadcast to the viewer; and program organization data generating means for generating, based on the viewing-related data, program organization data of the content to be broadcast to the viewer.

An advertisement allocation generation method according to the present disclosure includes: acquiring viewing-related data of a viewer from a terminal device with which the viewer views content; acquiring advertisement allocation condition data for allocating advertisement content to a program; and generating, based on the viewing-related data and the advertisement allocation condition data, advertisement allocation information obtained by allocating the advertisement content to content to be broadcast to the viewer.

A non-transitory computer-readable medium of the present disclosure stores a program for causing a computer to execute processing for: acquiring viewing-related data of a viewer from a terminal device with which the viewer views content; acquiring advertisement allocation condition data for allocating advertisement content to a program; and generating, based on the viewing-related data and the advertisement allocation condition data, advertisement allocation information obtained by allocating the advertisement content to content to be broadcast to the viewer.

### Advantageous Effects of Invention

According to the present disclosure, it is possible to provide an advertisement allocation generation device, a broadcast system, an advertisement allocation generation method, and a non-transitory computer-readable medium that can insert an advertisement reflecting requirements of a sponsor into content.

### BRIEF DESCRIPTION OF DRAWINGS

FIG. 1 is a block diagram illustrating a configuration of an advertisement allocation generation device according to a first example embodiment.

FIG. 2 is a block diagram illustrating a configuration of a broadcast system according to a second example embodiment.

FIG. 3 is a block diagram illustrating a configuration of an advertisement allocation generation device according to the second example embodiment.

FIG. 4 is a schematic diagram illustrating an operation of viewing-related data in a viewing data collection device according to the second example embodiment.

FIG. 5 is a flowchart illustrating an operation of the advertisement allocation generation device according to the second example embodiment.

FIG. 6 is a schematic diagram illustrating an example of an operation of the advertisement allocation generation device according to the second example embodiment.

FIG. 7 is a block diagram illustrating a configuration of a broadcast system according to a third example embodiment.

FIG. 8 is a flowchart illustrating operations of an advertisement allocation generation device and a program organization generation device according to the third example embodiment.

FIG. 9 is a schematic diagram illustrating an example of an operation of a program organization generation device according to the third example embodiment.

FIG. 10 is a schematic diagram illustrating an overview of a configuration and an operation of a broadcast system according to a fourth example embodiment.

FIG. 11 is a flowchart illustrating a content transmission method in the broadcast system according to the fourth example embodiment.

FIG. 12 is a block diagram illustrating a configuration of a computer according to an example embodiment.

### EXAMPLE EMBODIMENT

Example embodiments of the present disclosure are explained in detail below with reference to the drawings. In the drawings, the same or corresponding elements are denoted by the same reference numerals and signs and redundant explanation of the elements is omitted according to necessity for clarity of explanation.

“Content” indicates, for example, a video, a streaming moving image program with voice, or a VOD (Video On Demand) moving image program. In the present disclosure, “content” mainly refers to a streaming moving image program.

### First Example Embodiment

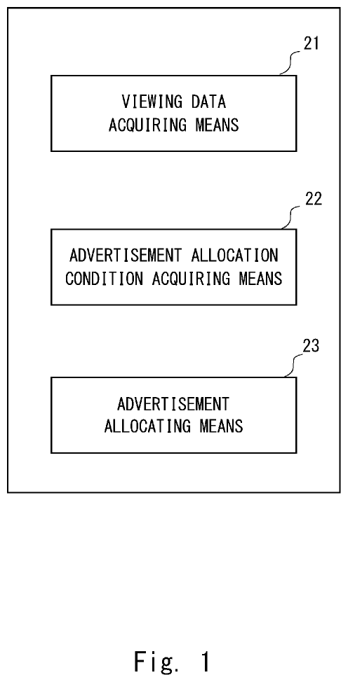

First, a configuration of an advertisement allocation generation device 2 according to a first example embodiment is explained with reference to FIG. 1. The advertisement allocation generation device 2 includes viewing data acquiring means 21, advertisement allocation condition acquiring means 22, and advertisement allocating means 23.

The viewing data acquiring means 21 acquires viewing-related data of a viewer from a terminal device with which the viewer views content. The advertisement allocation condition acquiring means 22 acquires advertisement allocation condition data for allocating advertisement content to a program. The advertisement allocating means 23 generates, based on the viewing-related data and the advertisement allocation condition data, advertisement allocation information obtained by allocating advertisement content to content to be broadcast to the viewer.

Therefore, using not only the viewing-related data of the viewer but also the advertisement allocation condition data, the advertisement allocation generation device 2 can insert an advertisement reflecting, for example, requirements of a sponsor into the content.

### Second Example Embodiment

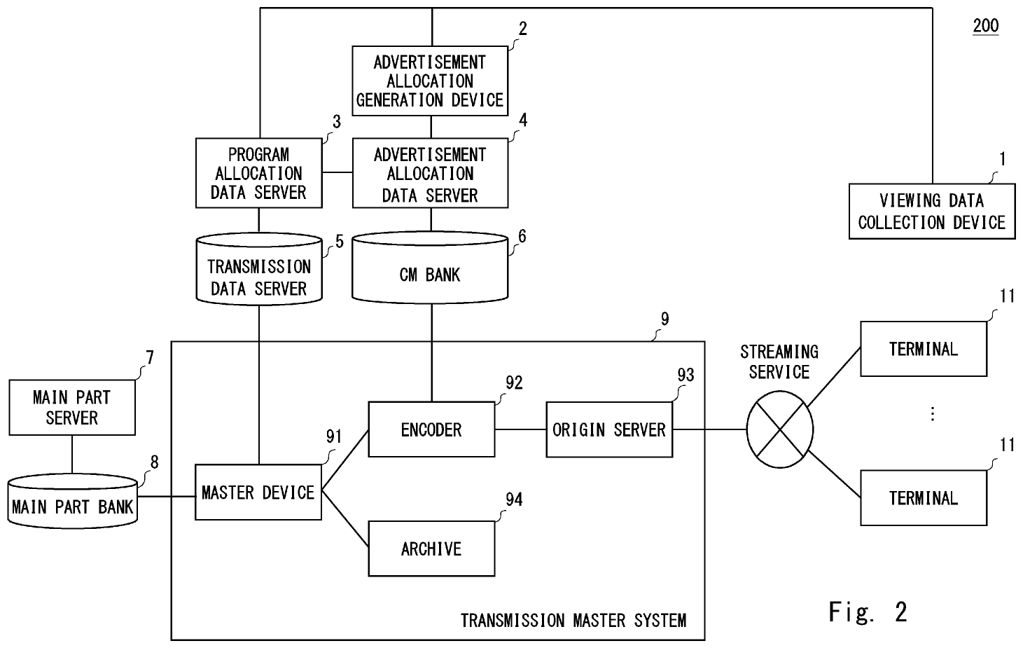

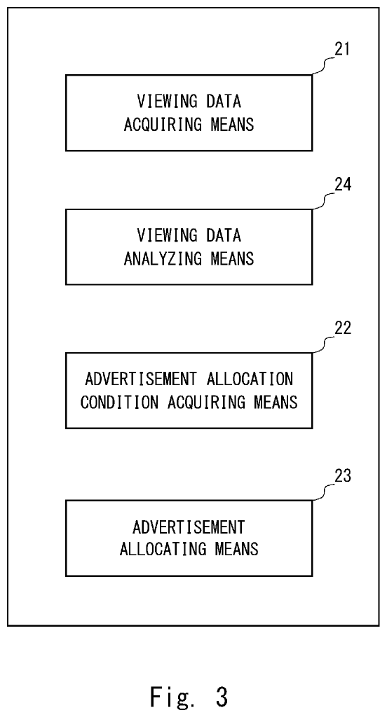

Subsequently, a configuration of a broadcast system 200 according to a second example embodiment is explained with reference to FIG. 2 and FIG. 3. In the following explanation, FIG. 2 is mainly referred to but FIG. 3 is referred to as appropriate.

As illustrated in FIG. 2, the broadcast system 200 includes a viewing data collection device 1, an advertisement allocation generation device 2, a program allocation data server 3, an advertisement allocation data server 4, a transmission data server 5, a CM bank 6, a main part server 7, a main part bank 8, a transmission master system 9, and terminals 11.

The viewing data collection device 1 collects viewing-related data of a viewer from the terminal 11. The viewing-related data is, for example, viewing history data or viewer attribute data. The viewing attribute data is attribute data such as gender, a birth year, and a residential place of the viewer. The viewing history data indicates a genre of content viewed by the viewer and history data in a viewing time of the content of the viewer. The viewing-related data also includes viewer action data relating to the viewing history data or the viewer attribute data. The viewer action data is data indicating an action such as a purchase action of the viewer.

As illustrated in FIG. 3, the advertisement allocation generation device 2 includes viewing data acquiring means 21, advertisement allocation condition acquiring means 22, and advertisement allocating means 23 and is disposed in a virtual environment on the cloud.

The viewing data acquiring means 21 acquires viewing-related data from the viewing data collection device 1.

A viewing data analyzing means 24 analyzes a viewing tendency or preference of the viewer based on the viewing-related data and generates viewing analysis data, which is an analysis result. Note that the viewing data collection device 1 may generate viewing analysis data based on the viewing-related data and supply the viewing analysis data to the advertisement allocation generation device 2.

The advertisement allocation condition acquiring means 22 acquires advertisement allocation condition data, which is a condition for allocating an advertisement to a program. The advertisement allocation condition data is requirements of a sponsor such as a time of viewing the advertisement content, a genre of a program into which the advertisement content is inserted, or the advertisement content (a product name).

The advertisement allocating means 23 automatically generates advertisement allocation information based on the viewing analysis data, the advertisement allocation condition data, and the advertisement content. The advertisement allocation information is information indicating advertisement content to be allocated to a program, that is, information indicating what kind of advertisement content is allocated to an advertisement frame of the program. The advertisement allocating means 23 selects, based on the advertisement allocation condition data, advertisement candidates to be allocated and determines, based on the viewing-related data, an advertisement to be allocated from the selected advertisement candidates.

The program allocation data server 3 generates program organization data and supplies the program organization data to the transmission data server 5. The program organization data is information indicating in which time period a program is organized and is, for example, a program guide indicating a schedule of a program to be broadcast. In the program organization data, a program frame is present and an advertisement frame into which an advertisement is inserted is present between a program frame and a program frame into which programs are inserted. In the program frame, a main part frame into which a main part is inserted is present and an advertisement frame is present between a main part frame and a main part frame. Here, the program allocation data server 3 allocates a main part file explained below to a main part frame of the program organization data. That is, the program allocation data server 3 associates the main part frame of the program organization data and identification information for identifying a main part file explained below. The program allocation data server 3 uses the advertisement allocation information acquired from the advertisement allocation data server 4 and allocates advertisement content explained below to an advertisement frame of a program in the program organization data. That is, the program allocation data server 3 associates the advertisement frame of the program of the program organization data and identification information for identifying the advertisement content.

The advertisement allocation data server 4 acquires advertisement allocation information from the advertisement allocation generation device 2. The advertisement allocation data server 4 generates advertisement allocation information. Then, the advertisement allocation data server 4 supplies the advertisement allocation information to the CM bank 6 or the program allocation data server 3.

The transmission data server 5 acquires program organization data from the program allocation data server 3 and stores the program organization data. Then, the transmission data server 5 supplies the program organization data to the transmission master system 9.

The CM bank 6 stores advertisement content and supplies the advertisement content to the transmission master system 9. The advertisement content indicates an advertisement that is inserted before and after a program or halfway in the program and distributed to the viewer.

The main part server 7 generates a main part file and supplies the stored main part file to the main part bank 8. The main part file includes moving image content and is generated by a broadcast station or an individual producer.

The main part bank 8 stores the main part file and supplies the stored main part file to the transmission master system 9.

The transmission master system 9 includes a master device 91, an encoder 92, an origin server 93, and an archive 94 and is disposed in a virtual environment on the cloud.

The master device 91 generates program content using the main part file acquired from the main part bank 8 and the program organization data acquired from the transmission data server 5. Specifically, the master device 91 combines main part files according to the program organization data to generate a program content including the main part files and an advertisement frame into which an advertisement is inserted. Then, the master device 91 acquires viewing broadcast station information indicating a broadcast station to be viewed from the terminal 11 and supplies program content corresponding to the viewing broadcast station information to the encoder 92.

The encoder 92 generates content to be transmitted to the viewer using the advertisement content acquired from the CM bank 6 and the program content acquired from the master device 91. Specifically, the encoder 92 inserts the advertisement content corresponding to the advertisement frame included in the program content into the content using the advertisement allocation information. Then, the encoder 92 performs encoding such as a change of a data format and compression of the content and supplies the encoded content to the origin server 93.

The origin server 93 acquires the encoded content from the encoder 92. The origin server 93 transmits the content to the terminal 11 of the viewer via a network such as the Internet. The origin server 93 transmits, for example, the content to the terminal 11 by streaming. The origin server 93 may store the acquired content.

The archive 94 stores the content acquired from the master device 91. The stored content is used for, for example, a VOD service.

The terminal 11 is a mobile terminal such as a smartphone or a tablet or a stationary terminal such as a TV or a PC (Personal Computer). The terminal 11 acquires content from the origin server 93 by streaming and outputs the acquired content. For example, the terminal 11 includes a dedicated application and, when the application is started, outputs a broadcast station list to which content can be distributed and, when a broadcast station is selected by the user, acquires content corresponding to the broadcast station from the origin server 93, and outputs the content to a display. The terminal 11 supplies viewing-related data to the viewing data collection device 1 at predetermined timing or at a predetermined interval.

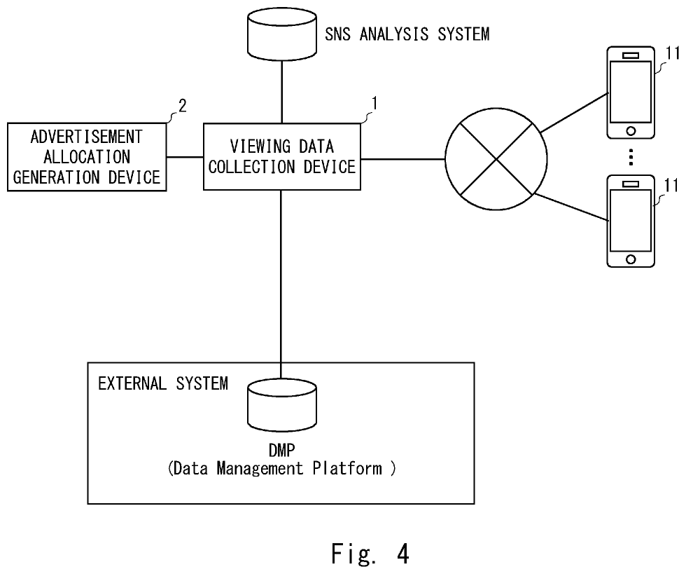

Subsequently, an operation of the viewing data collection device 1 according to the second example embodiment is explained with reference to FIG. 4.

As illustrated in FIG. 4, the viewing data collection device 1 acquires viewing history data and viewer attribute data as viewing-related data from the terminal 11. The viewing attribute data is attribute data such as gender, a birth year, and a residential place of the viewer. For example, a simultaneous distribution application for simultaneous distribution viewing is installed in the terminal 11. The viewing data collection device 1 acquires viewing attribute data obtained by the viewer answering a questionnaire at the time of application installation using an application for viewing distribution in the terminal 11. The viewing history data indicates a genre of content viewed by the viewer and history data of a viewing time of the content of the viewer. For example, the viewing data collection device 1 stores viewing history data of the viewer together with a viewer ID, an application ID, or an advertisement ID in a log server at the time of viewing the content of the viewer in the terminal 11.

In addition, the viewing data collection device 1 may acquire, as the viewing-related data, viewer action data obtained by a panel analysis from an SNS (Social networking service) analysis system or a DMP (Data Management Platform) connected to the outside. The viewer action data indicates an action of the viewer of the terminal 11. If action data of the viewer who has viewed an advertisement can be acquired by panel investigation, it is also possible to track even conversion (presence or absence of commodity purchase of the viewer).

Then, the viewing data collection device 1 supplies the acquired viewing-related data to the advertisement allocation generation device 2.

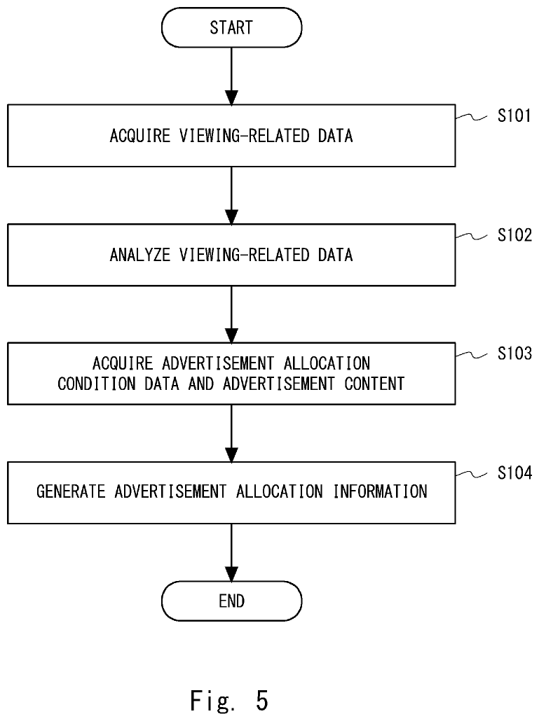

Subsequently, an operation for generating advertisement allocation information of the advertisement allocation generation device 2 according to the second example embodiment is explained with reference to FIG. 5.

As illustrated in FIG. 5, first, the viewing data acquiring means 21 of the advertisement allocation generation device 2 acquires the viewing-related data from the viewing data collection device 1 (step S101).

Next, the viewing data analyzing means 24 analyzes the acquired viewing-related data (step S102).

Subsequently, the advertisement allocation condition acquiring means 22 acquires advertisement allocation condition data and advertisement content from a storage region of the own device (step S103).

Subsequently, the advertisement allocating means 23 generates advertisement allocation information based on the viewing analysis data, the advertisement allocation condition, and the advertisement content (step S104).

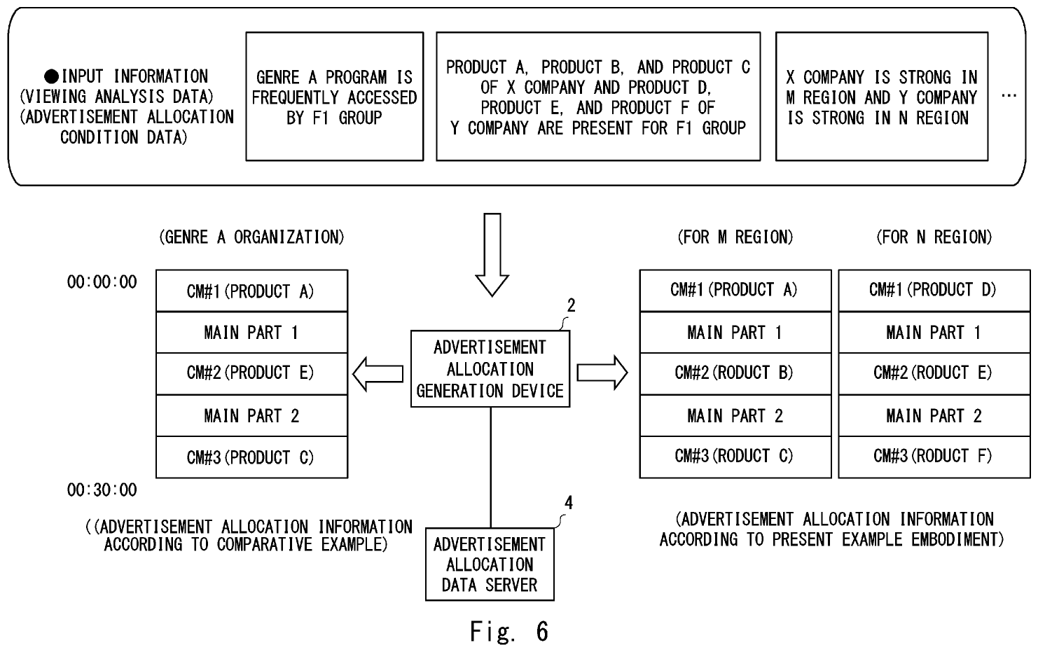

Subsequently, an example of an operation for generating advertisement allocation information of the advertisement allocation generation device 2 according to the second example embodiment is explained with reference to FIG. 6.

First, the advertisement allocation generation device 2 analyzes viewing-related data and generates viewing analysis data indicating a viewing tendency or preference of the viewer such as the number of accesses for each time period, the number of viewers for each program, a viewer attribute for each program, an action of the viewer from advertisement viewing, and conversion. Here, the advertisement allocation generation device 2 groups viewer groups into age groups such as C (4 to 12 years old), T (13 to 19 years old), F1/M1 (20 to 34 years old), F2/M2 (35 to 49 years old), and F3/M3 (50 years old or older).

Then, the advertisement allocation generation device 2 obtains, as input information, “a genre A program has many accesses of the F1 group (female and 20 to 34 years old)” from the viewing analysis data. Subsequently, the advertisement allocation generation device 2 obtains, as input information, “a product A, a product B, and a product C of an X company and a product D, a product E, and a product F of Y company are present for the F1 group” from the advertisement allocation condition data. Subsequently, the advertisement allocation generation device 2 obtains, as input information, “the X company is strong in an M region and the Y company is strong in an N region” from the advertisement allocation condition data.

Then, the advertisement allocation generation device 2 generates advertisement allocation information using the input information and the advertisement content explained above.

In a comparative example, the advertisement allocation generation device 2 generates the advertisement allocation information without using the viewing analysis data and the advertisement allocation condition data. In the comparative example, the advertisement allocation generation device 2 generates advertisement allocation information for allocating advertisement content of the product A, advertisement content of the product E, and advertisement content of the product C to the genre A program.

In the present example embodiment, unlike the comparative example, the advertisement allocation generation device 2 generates advertisement allocation information for allocating the advertisement content of the product A, the advertisement content of the product B, and the advertisement content of the product C to the genre A program broadcast to the M region. For example, in a genre A program broadcast to the M region, advertisement content of the product A is allocated to a frame of an advertisement #1, advertisement content of the product B is allocated to a frame of an advertisement #2, and advertisement content of the product C is allocated to a frame of an advertisement #3. The advertisement allocation generation device 2 generates advertisement allocation information for allocating advertisement content of the product D, advertisement content of the product E, and advertisement content of the product F to the genre A program broadcast to the N region. For example, in the genre A program broadcast to N region, the advertisement content of the product D is allocated to the frame of the advertisement #1, the advertisement content of the product E is allocated to the frame of the advertisement #2, and the advertisement content of the product F is allocated to the frame of the advertisement #3.

In the present example embodiment, the advertisement allocation generation device 2 can provide, a viewer group that frequently access a program, advertisement content of a product for the viewer group and can change, according to a region where the influence of a provider of an advertisement is strong, an advertisement content of a product to be provided. Therefore, the advertisement allocation generation device 2 can provide, to the viewer, effective advertisement content in which an intention of the viewer is reflected on an intention of the sponsor.

Note that the advertisement allocation generation device 2 may select candidates of advertisement content based on advertisement allocation condition data and determine advertisement content to be allocated to an advertisement frame of a program based on viewing analysis data from the candidates of the advertisement content.

The advertisement allocation condition indicated by the advertisement allocation condition data, in particular, the sponsor requirement is indicated by the following examples.

It is desired to distribute advertisement content targeting working women in their thirties.

Since a commodity to be released this time is distributed all over the country, it is desired to distribute advertisement content all over the country.

A commodity target is housewives in their 30's to 40's and it is desired to distribute advertisement content in a short campaign period.

This time, it is desired to distribute campaign advertisement content in the Kanto region and, if there is a response, distribute the campaign advertisement content throughout the country.

It is not desired to distribute advertisement content to a program including a violent scene or a bloody scene even a little.

The advertisement allocation generation device 2 may allocate advertisement content having a predetermined relation to a predetermined program. The advertisement content having the predetermined relation is, for example, advertisement content present in the same category such as a food category. The advertisement allocation generation device 2 may allocate advertisement content conforming to a predetermined story to the predetermined program. The advertisement content conforming to the predetermined story is, for example, advertisement content of a local travel agency introduced in a program for a travel program. When an advertisement frame is 1 minute, four pieces of advertisement content of 15 seconds may be allocated. The advertisement allocation generation device 2 may check that advertisement content of a competitor is not allocated in the same program.

Therefore, the broadcast system 200 according to the second example embodiment can provide, to the viewer, advertisement content reflecting an intention of the viewer by reflecting the viewing analysis data on the advertisement allocation information. In addition, the broadcast system 200 can provide, to the viewer, effective advertisement content reflecting an intention of a sponsor or the like by reflecting advertisement allocation condition, which is a requirement of the sponsor, on the advertisement allocation information.

The broadcast system 200 automatically allocates an advertisement to content. Therefore, when advertisement allocation is implemented, specialized knowledge of advertisement allocation is not required and even a non-expert can contribute to improvement in quality of advertisement sales.

### Third Example Embodiment

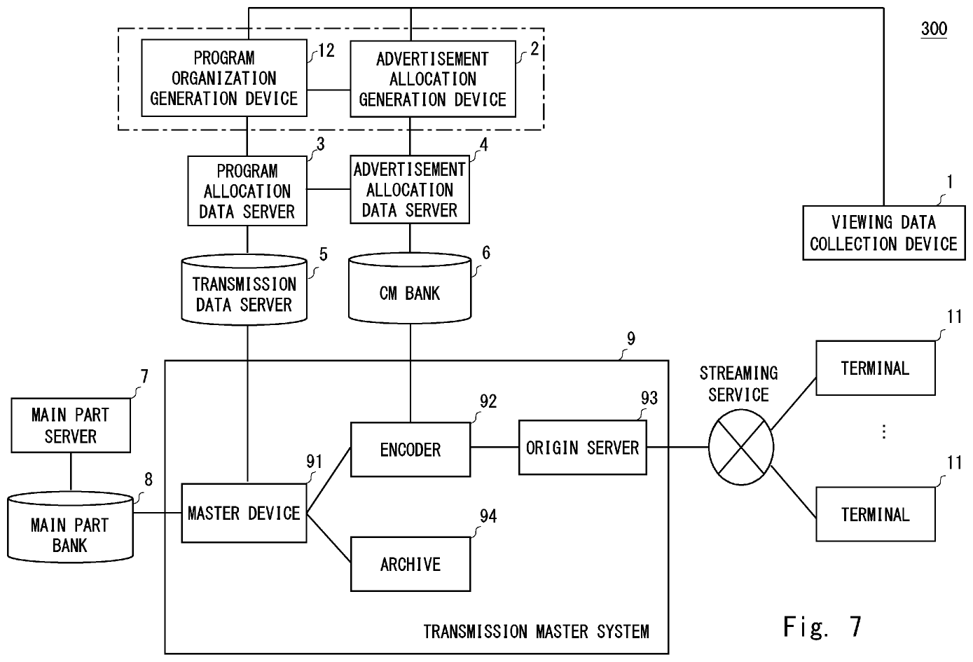

Subsequently, a configuration of a broadcast system 300 according to a third example embodiment is explained with reference to FIG. 7. The broadcast system 300 further includes a program organization generation device 12 in the broadcast system 200 according to the second example embodiment.

The program organization generation device 12 acquires viewing-related data of a viewer from the terminal 11 with which the viewer views content. The program organization generation device 12 generates, based on the viewing-related data, program organization data of content to be broadcast to the viewer. Specifically, program organization generation device 12 acquires viewing-related data of the viewer from the terminal 11 with which the viewer views content. The program organization generation device 12 acquires organization policy data indicating a policy of program organization of a broadcast station. The program organization generation device 12 generates program organization data based on the viewing-related data and the organization policy data. Here, the program organization generation device 12 selects program candidates based on the organization policy data and determines a program to be included in a program organization table from the selected program candidate based on the viewing-related data. More specifically, program organization generation device 12 acquires viewing-related data of the viewer from the terminal 11 with which the viewer views content. The program organization generation device 12 analyzes the viewing-related data and generates viewing analysis data indicating a viewing tendency or preference of the viewer. The program organization generation device 12 acquires organization policy data indicating a policy of program organization of a broadcast station. The program organization generation device 12 generates program organization data based on the viewing analysis data and the organization policy data.

Then, the program organization generation device 12 supplies the generated program organization data to the program allocation data server 3. Here, the program organization generation device 12 cooperates with the advertisement allocation generation device 2 and is installed in a virtual space on the cloud.

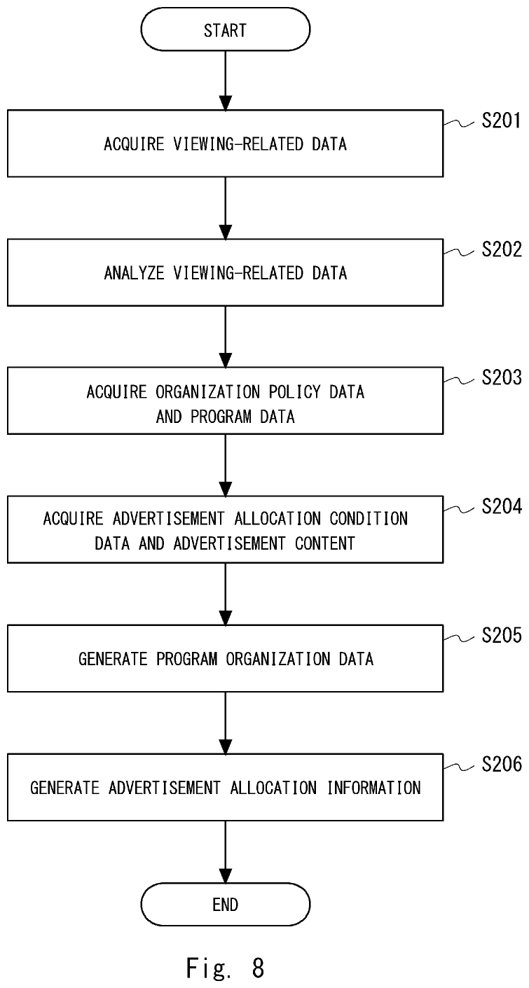

Subsequently, operations of the advertisement allocation generation device 2 and the program organization generation device 12 according to the third example embodiment are explained with reference to FIG. 8.

First, the program organization generation device 12 acquires viewing-related data from the viewing data collection device 1 (step S201). Subsequently, the program organization generation device 12 analyzes the acquired viewing-related data and generates viewing analysis data (step S202). An analysis method is the same as the analysis method in step S102 explained above.

Subsequently, the program organization generation device 12 acquires organization condition data and program data from a storage region of the own device (step S203).

Subsequently, the advertisement allocation generation device 2 acquires advertisement allocation condition data and advertisement content from the storage region of the own device (step S204).

Subsequently, the program organization generation device 12 generates program organization data based on the viewing analysis data, the organization condition data, and the program data (step S205). For example, the program organization generation device 12 generates program organization data for a predetermined viewer group.

Subsequently, the advertisement allocation generation device 2 generates advertisement allocation information based on the viewing analysis data, the advertisement allocation condition, and the advertisement content (step S206). The advertisement allocation generation device 2 generates advertisement allocation information with the same method as step S104 explained above.

Note that the advertisement allocation generation device 2 may integrate the advertisement allocation information generated by the advertisement allocation generation device 2 with the program organization data generated by the program organization generation device 12. For example, the program organization generation device 12 generates program organization data for a predetermined viewer group. The advertisement allocation generation device 2 allocates advertisement content for the viewer group to a program configuring the program organization data.

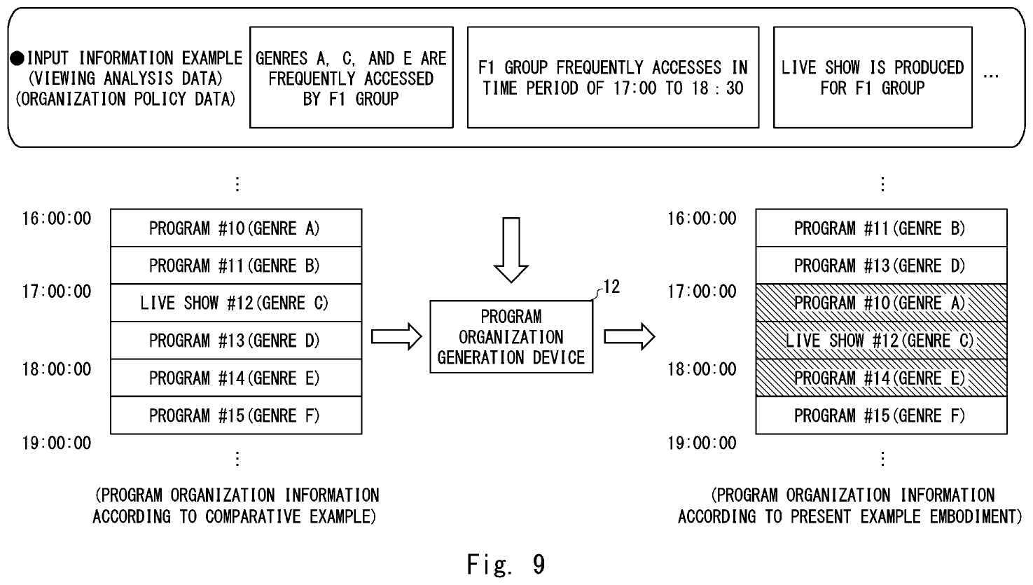

Subsequently, a specific operation of the program organization generation device 12 according to the third example embodiment is explained with reference to FIG. 9.

First, the program organization generation device 12 analyzes the viewing-related data and generates viewing analysis data. Here, the program organization generation device 12 generates groups a viewer group into age groups such as C (4 to 12 years old), T (13 to 19 years old), F1/M1 (20 to 34 years old), F2/M2 (35 to 49 years old), and F3/M3 (50 years old or older) and generate viewing analysis data. Then, the program organization generation device 12 obtains, as input information, “a genre A program, a genre C program, and a genre E program have many accesses of the F1 group” from the viewing analysis data. Subsequently, the program organization generation device 12 obtains, as input information, “the F1 group frequently accesses in a time period of 17:00 to 18:30” from the viewing analysis data. Subsequently, the program organization generation device 12 obtains, as input information, “a live show is produced for the F1 group” from the organization policy data.

Then, the program organization generation device 12 generates program organization data using the input information and the program data explained above.

In a comparative example, the program organization generation device 12 generates program organization data without using the viewing analysis data and the organization policy data. In the present example embodiment, unlike the comparative example, the program organization generation device 12 generates program organization data obtained by organizing a program #10 of the genre A program, a live show #12 of the genre C program, and a program #14 of the genre E program, which are frequently accessed by the F1 group in the time period of 17:00 to 18:30 when the F1 group frequently accesses. The program organization generation device 12 reflects an organization policy of the broadcast station and generates program organization data obtained by organizing the live show #12 of the genre C program produced for the F1 group.

In the present example embodiment, the program organization generation device 12 can generate program organization data obtained by organizing programs frequently accessed by a predetermined viewer group in a time period when the viewer group frequently accesses and can generate program organization data also corresponding to the organization policy of the broadcast station. In the present example embodiment, the program organization generation device 12 can provide, to the viewer, an effective program in which an intention of the viewer is reflected on an intention of the broadcast station.

Note that the program organization generation device 12 may select program candidates based on organization policy data, and determine, based on the viewing-related data, a program to be included in the program organization data from the selected program candidates.

An organization policy indicated by the organization policy data, in particular, an organization policy of the broadcast station is indicated in the following example.

At night on Sunday, programs that can be enjoyed by all family members are organized.

In the evening on Saturday and Sunday, animation for children is organized.

In the morning on Monday to Friday morning (5:00 to 8:00), a news, weather or traffic information program for going to work or school is organized. In the morning on Monday to Friday (8:00 to 10:00), life information programs for housewives are organized.

In the day time on Monday to Friday, since office workers are on lunch break, many news information programs are organized.

In the midnight period, slightly sharp experimental programs to be shifted to a GP zone (19:00 to 23:00) in the future are organized.

The broadcast system 300 according to the third example embodiment can provide, to the viewer, an effective program in which an intention of the viewer is reflected on an intention of the broadcast station by using the viewing analysis data and the organization policy data. For example, when the broadcast system 300 generates program organization data obtained by intensively organizing programs popular to viewers, it is possible to induce an increase in the number of accesses of viewers.

The broadcast system 300 automatically generates program organization using viewer information. Accordingly, the broadcast system 300 does not expertise for program organization and even a non-expert can easily generate the program organization and it can be expected that the quality of a broadcast service is improved.

The broadcast system 300 not only allocates advertisement content based on viewer information but also execute program organization based on viewer information. Accordingly, it is possible to transmit optimum content adjusted to the viewer.

### Fourth Example Embodiment

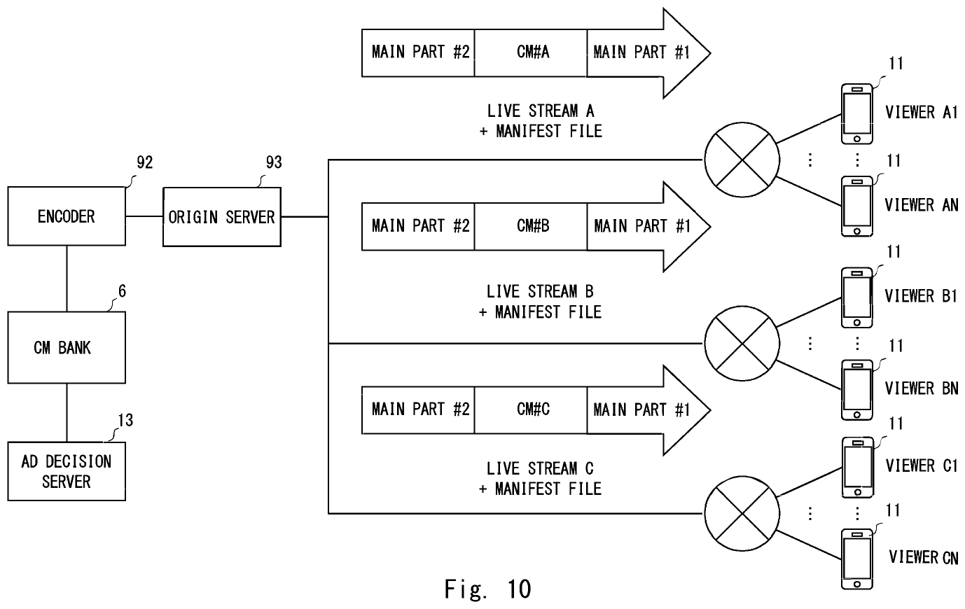

Subsequently, a configuration of a broadcast system 400 according to a fourth example embodiment is explained with reference to FIG. 10. The broadcast system 400 is obtained by adding a configuration of an AD (Ad) decision server 13 to the broadcast system 200 according to the second example embodiment or the broadcast system 300 according to the third example embodiment. The broadcast system 400 includes a plurality of encoders 92. A function that can generate a plurality of kinds of streaming is added.

The encoder 92 inserts advertisement content selected by the AD decision server 13 into content. Here, the encoder 92 inserts a predetermined advertisement into an advertisement frame of the content. Then, the encoder 92 transmits the content into which the advertisement content is inserted to the terminal 11 of a viewer via a network such as the Internet. The encoder 92 performs group targeting using an SSAI (Server Side Ad-Insertion) scheme and inserts advertisement content into content for each of viewer groups. The SSAI scheme means a distribution scheme for transmission to a terminal by streaming in which a CM is added to a main part on the distribution side. Note that an MEC (Multi-access Edge Computing) server may allocate an advertisement on an edge side.

The number of encoders 92 equivalent to the number of streams transmitted to the terminal 11 of the viewer are provided. For example, in the example illustrated in FIG. 10, three encoders 92 are provided.

The AD decision server 13 is a server that selects an advertisement based on viewer-related data.

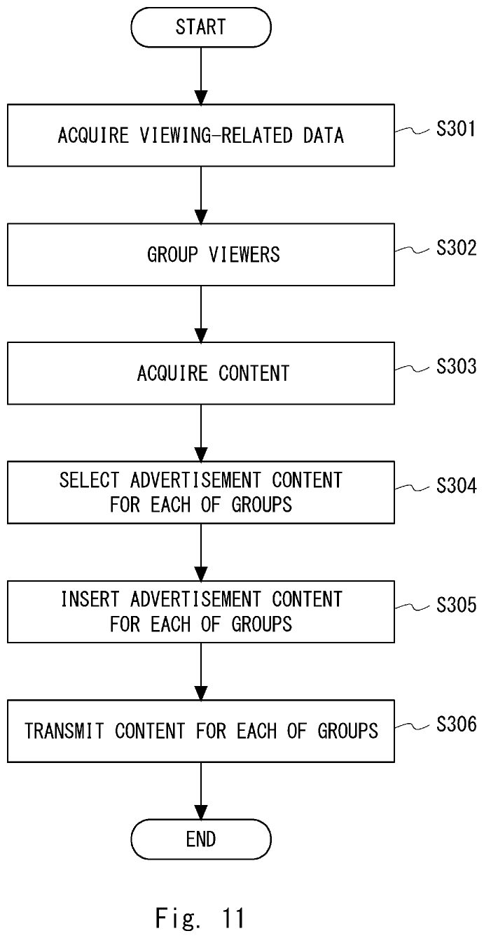

Subsequently, a configuration of the broadcast system 400 according to the fourth example embodiment is explained with reference to FIG. 10 and FIG. 11.

The AD decision server 13 acquires viewing-related data from the terminal 11 (step S301).

Subsequently, the AD decision server 13 groups viewers based on the viewing-related data (step S302). For example, the AD decision server 13 groups viewers based on the viewing-related data under conditions such as where the viewers reside in Kanto and Kinki or are women in their 20s to 30s or women in their 40s to 50s.

Subsequently, the encoder 92 acquires content including a main part of a program and an advertisement frame from the master device 91 (step S303).

Specifically, the encoder 92 acquires content including a main part #1, an advertisement frame, and a main part #2 from the master device 91.

Subsequently, the AD decision server 13 selects advertisement content to be allocated for each of groups of viewers (step S304). Specifically, the AD decision server 13 analyzes the viewing-related data, analyzes a viewing tendency and preference of the viewer group, and generates viewing analysis data. The AD decision server 13 selects an advertisement using the viewing analysis data. Note that the AD decision server 13 may select advertisement content to be allocated to content with reference to the advertisement allocation information generated by the advertisement allocation generation device 2 according to the second example embodiment or the third example embodiment. Then, the AD decision server 13 supplies the advertisement content selected for each of the groups of the viewers to the encoder 92 via the CM bank 6.

Subsequently, the encoder 92 inserts the advertisement content selected for each of the groups of the viewers into an advertisement frame of the content (step S305). Specifically, the encoder 92 inserts an advertisement selected for each of the groups of the viewers into an advertisement frame of a live stream. Here, the encoder 92 inserts the advertisement into streaming data using an advertisement effective trigger signal called SCTE (Society of Cable Telecommunications Engineers)-35 generated by the transmission master system 9. The SCTE-35 is a standard for dynamically inserting an advertisement into a stream.

Subsequently, the encoder 92 transmits content including a main part and an advertisement to the terminal 11 for each of the groups of the viewers via the origin server 93. Specifically, the encoder 92 transmits a live stream A including a main part #1, an advertisement #A, and a main part #2 to the terminals 11 of a viewer group A (a viewer A1 to a viewer AN). The encoder 92 transmits a live stream B including the main part #1, an advertisement #B, and the main part #2 to the terminals 11 of a viewer group B (a viewer Bl to a viewer BN). The encoder 92 transmits a live stream C including the main part #1, an advertisement #C, and the main part #2 to the terminals 11 of a viewer group C (a viewer Cl to a viewer CN). Here, manifest files are attached to the live stream A, the live stream B, and the live stream C. The manifest files indicate control files indicating transmission order of programs and CMs.

The broadcast system 400 according to the fourth example embodiment transmits content to the terminal 11 according to an SSAI scheme. Accordingly, by adopting the SSAI scheme, the broadcast system 400 can prevent a delay due to buffering of the terminal 11 and advertisement block due to an advertisement block function.

The broadcast system 400 can distribute an appropriate advertisement while reducing a load on a server by performing group targeting in the SSAI scheme. For example, even when advertisement content for an F1 group is allocated to content, advertisement content can be provided to each of groups for an F2 group, an M1 group, and an M2 group different from the F1 group.

Note that the present invention is not limited to the example embodiments explained above and can be changed as appropriate without departing from the scope of the present invention.

### <Hardware Configuration>

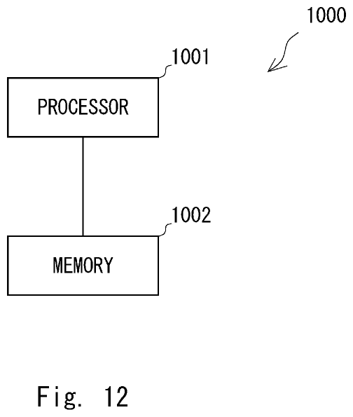

Subsequently, a hardware configuration example of a computer 1000 relating to the devices (for example, the advertisement allocation generation device 2) configuring the advertisement allocation generation device 2, the broadcast system 200, the broadcast system 300, and the broadcast system 400 is explained with reference to FIG. 12. In FIG. 12, the computer 1000 includes a processor 1001 and a memory 1002. The processor 1001 may be, for example, a microprocessor, a MPU (Micro Processing Unit), or a CPU (Central Processing Unit). The processor 1001 may include a plurality of processors. The memory 1002 is configured by a combination of a volatile memory and a nonvolatile memory. The memory 1002 may include a storage disposed away from the processor 1001. In this case, the processor 1001 may access the memory 1002 via a not-illustrated I/O interface.

The devices in the example embodiments explained above may be configured by hardware, software, or both, may be configured by one piece of hardware or software, or may be configured by a plurality of pieces of hardware or software. The functions (the processing) of the devices in the example embodiments explained above may be realized by a computer. For example, programs for performing the methods in the example embodiments may be stored in the memory 1002 and the functions may be realized by the processor 1001 executing the programs stored in the memory 1002.

The programs explained above can be stored and supplied to the computer using various types of non-transitory computer-readable media. The non-transitory computer-readable media include various types of tangible storage media. Examples of non-transitory computer-readable medium include a magnetic recording medium (for example, a flexible disk, a magnetic tape, or a hard disk drive), a magneto-optical recording medium (for example, a magneto-optical disk), a CD-ROM (Read Only Memory), a CD-R, a CD-R/W, and a semiconductor memory (for example, a mask ROM, a PROM (Programmable ROM), an EPROM (Erasable PROM), a flash ROM, and a RAM (random Access memory)). The programs may be supplied to the computer through various types of transitory computer-readable media. Examples of the transitory computer-readable media include electrical signals, optical signals, and electromagnetic waves. The transitory computer-readable media can supply the programs to the computer via wired or wireless communication paths such as wires and optical fiber.

A part or all of the example embodiments explained above can be explained as in the following supplementary notes but are not limited to the following supplementary notes.

### (Supplementary Note 1)

An advertisement allocation generation device including:
viewing data acquiring means for acquiring viewing-related data of a viewer from a terminal device with which the viewer views content;
advertisement allocation condition acquiring means for acquiring advertisement allocation condition data for allocating advertisement content to a program; and
advertisement allocating means for generating, based on the viewing-related data and the advertisement allocation condition data, advertisement allocation information obtained by allocating the advertisement content to a program of content to be broadcast to the viewer.

### (Supplementary Note 2)

The advertisement allocation generation device described in Supplementary note 1, wherein the advertisement allocating means selects, based on the advertisement allocation condition data, advertisement candidates to be allocated and determines, based on the viewing-related data, an advertisement to be allocated from the selected advertisement candidates.

### (Supplementary Note 3)

The advertisement allocation generation device described in Supplementary note 1 or 2, wherein the advertisement allocation condition data includes a time of time of viewing advertisement, a genre of the advertisement, or a requirement of a sponsor of the advertisement.

### (Supplementary Note 4)

The advertisement allocation generation device described in any one of Supplementary notes 1 to 3, further including viewing data analyzing means for analyzing a viewing tendency or preference of the viewer based on the viewing-related data,
wherein the advertisement allocating means allocates the advertisement according to a result of the analysis.

### (Supplementary Note 5)

The advertisement allocation generation device described in any one of Supplementary notes 1 to 4, wherein the viewing-related data includes viewing history data or viewer attribute data of the viewer.

### (Supplementary Note 6)

The advertisement allocation generation device described in Supplementary note 5, wherein the viewing-related data includes viewer action data relating to the viewing history data or the viewer attribute data.

### (Supplementary Note 7)

The advertisement allocation generation device described in any one of Supplementary notes 1 to 6, wherein the advertisement allocating means allocates an advertisement having a predetermined relation in the program.

### (Supplementary Note 8)

The advertisement allocation generation device described in Supplementary note 7, wherein the advertisement allocating means allocates an advertisement according to a predetermined story in the program.

### (Supplementary Note 9)

The advertisement allocation generation device described in any one of Supplementary notes 1 to 8, wherein the advertisement allocation generation device is disposed in a virtual environment on a cloud.

### (Supplementary Note 10)

A broadcast system including:
viewing-related data acquiring means for acquiring viewing-related data of a viewer from a terminal device with which the viewer views content;
advertisement allocation condition acquiring means for acquiring advertisement allocation condition data for allocating an advertisement to a program;
advertisement allocating means for generating, based on the viewing-related data and the advertisement allocation condition data, advertisement allocation information obtained by allocating the advertisement to a program of content to be broadcast to the viewer; and
program organization generating means for generating, based on the viewing-related data, program organization data of a content to be broadcast to the viewer.

### (Supplementary Note 11)

The broadcast system described in Supplementary note 10, further including organization policy acquiring means for acquiring organization policy data indicating a policy of program organization,
wherein the program organization generating means generates the program organization data based on the viewing-related data and the organization policy data.

### (Supplementary Note 12)

The broadcast system described in Supplementary note 11, wherein the program organization generating means selects a program candidate based on the organization policy data and determines a program to be included in a program organization table from the selected program candidate based on the viewing-related data.

### (Supplementary Note 13)

The broadcast system described in any one of Supplementary notes 10 to 12, further including viewing data analyzing means for analyzing a viewing tendency or preference of the viewer based on the viewing-related data, wherein the program organization generating means generates the program organization data according to a result of the analysis.

### (Supplementary Note 14)

The broadcast system described in any one of Supplementary notes 10 to 13, further including:
content generating means for generating the content in a streaming format based on the program organization data;
advertisement inserting means for inserting advertisement content into the generated content based on the advertisement allocation information; and
transmitting means for transmitting the content into which the advertisement content is inserted to a terminal device of the viewer.

### (Supplementary Note 15)

The broadcast system described in Supplementary note 14, wherein the advertisement inserting means inserts the advertisement content according to an SSAI (Server Side Ad-Insertion) scheme.

### (Supplementary Note 16)

The broadcast system described in Supplementary note 14 or 15, further including grouping means for grouping terminal devices of the viewer,
wherein the advertisement insertion means inserts advertisement content into the content for each of groups of the terminal devices, and
the transmitting means transmits the content for each of the groups of the terminal devices.

### (Supplementary Note 17)

The broadcast system described in any one of Supplementary notes 10 to 16, wherein the broadcast system is disposed in a virtual environment on a cloud.

### (Supplementary Note 18)

An advertisement allocation generation method including:
acquiring viewing-related data of a viewer from a terminal device with which the viewer views content;
acquiring advertisement allocation condition data for allocating advertisement content to a program; and
generating, based on the viewing-related data and the advertisement allocation condition data, advertisement allocation information obtained by allocating the advertisement content to a program of content to be broadcast to the viewer.

### (Supplementary Note 19)

A non-transitory computer-readable medium storing a program for causing a computer to execute processing for:
acquiring viewing-related data of a viewer from a terminal device with which the viewer views content;
acquiring advertisement allocation condition data for allocating advertisement content to a program; and
generating, based on the viewing-related data and the advertisement allocation condition data, advertisement allocation information obtained by allocating the advertisement content to a program of content to be broadcast to the viewer.

### REFERENCE SIGNS LIST

1 VIEWING DATA COLLECTION DEVICE
2 ADVERTISEMENT ALLOCATION GENERATION DEVICE
3 PROGRAM ALLOCATION DATA SERVER
4 ADVERTISEMENT ALLOCATION DATA SERVER
5 TRANSMISSION DATA SERVER
6 CM BANK
7 MAIN PART SERVER
8 MAIN PART BANK
9 TRANSMISSION MASTER SYSTEM
11 TERMINAL
12 PROGRAM ORGANIZATION GENERATION DEVICE
13 AD DECISION SERVER
21 VIEWING DATA ACQUIRING MEANS
22 ADVERTISEMENT ALLOCATION CONDITION ACQUIRING MEANS
23 ADVERTISEMENT ALLOCATING MEANS
24 VIEWING DATA ANALYZING MEANS
91 MASTER DEVICE
92 ENCODER
93 ORIGIN SERVER
94 ARCHIVE
200 BROADCAST SYSTEM
300 BROADCAST SYSTEM
400 BROADCAST SYSTEM
1000 COMPUTER
1001 PROCESSOR
1002 MEMORY

What is claimed is:

1. An advertisement allocation generation device comprising:
at least one memory that is configured to store instructions; and
at least one processor that is configured to execute the instructions to:
acquire viewing-related data of a viewer from a terminal device with which the viewer views content;
acquire advertisement allocation condition data for allocating advertisement content to a program; and
generate, based on the viewing-related data and the advertisement allocation condition data, advertisement allocation information obtained by allocating the advertisement content to a program of content to be broadcast to the viewer.

2. The advertisement allocation generation device according to claim 1, wherein the at least one processor that is configured to execute the instructions to select, based on the advertisement allocation condition data, advertisement content candidates to be allocated and determines, based on the viewing-related data, an advertisement content to be allocated from the selected advertisement content candidates.

3. The advertisement allocation generation device according to claim 1, wherein the advertisement allocation condition data includes a time of time of viewing advertisement content, a genre of the advertisement content, or a requirement of a sponsor of the advertisement content.

4. The advertisement allocation generation device according to claim 1, wherein the at least one processor that is configured to execute the instructions to analyze a viewing tendency or preference of the viewer based on the viewing-related data,
wherein the at least one processor that is configured to execute the instructions to allocate the advertisement content according to a result of the analysis.

5. The advertisement allocation generation device according to claim 1, wherein the viewing-related data includes viewing history data or viewer attribute data of the viewer.

6. The advertisement allocation generation device according to claim 5, wherein the viewing-related data includes viewer action data relating to the viewing history data or the viewer attribute data.

7. The advertisement allocation generation device according to claim 1, wherein the at least one processor that is configured to execute the instructions to allocate an advertisement having a predetermined relation in the program.

8. The advertisement allocation generation device according to claim 7, wherein the at least one processor that is configured to execute the instructions to allocate an advertisement according to a predetermined story in the program.

9. The advertisement allocation generation device according to claim 1, wherein the advertisement allocation generation device is disposed in a virtual environment on a cloud.

10. A broadcast system comprising:
at least one memory that is configured to store instructions; and
at least one processor that is configured to execute the instructions to:
acquire viewing-related data of a viewer from a terminal device with which the viewer views content;
acquire advertisement allocation condition data for allocating an advertisement to a program;
generate, based on the viewing-related data and the advertisement allocation condition data, advertisement allocation information obtained by allocating the advertisement to a program of content to be broadcast to the viewer; and
generate, based on the viewing-related data, program organization data of a content to be broadcast to the viewer.

11. The broadcast system according to claim 10, wherein the at least one processor that is configured to execute the instructions to acquire organization policy data indicating a policy of program organization,
wherein the at least one processor that is configured to generate the program organization based on the viewing-related data and the organization policy data.

12. The broadcast system according to claim 11, wherein the at least one processor that is configured to select a program candidate based on the organization policy data and determine a program to be included in a program organization table from the selected program candidate based on the viewing-related data.

13. The broadcast system according to claim 10, wherein the at least one processor that is configured to execute the instructions to analyze a viewing tendency or preference of the viewer based on the viewing-related data,
wherein the at least one processor that is configured to generate the program organization data according to a result of the analysis.

14. The broadcast system according to claim 10, wherein the at least one processor that is configured to:
generate the content in a streaming format based on the program organization data;
insert advertisement content into the generated content based on the advertisement allocation information; and
transmit the content into which the advertisement content is inserted to a terminal device of the viewer.

15. The broadcast system according to claim 14, wherein the at least one processor that is configured to insert the advertisement content according to an SSAI (Server Side Ad-Insertion) scheme.

16. The broadcast system according to claim 14, wherein the at least one processor that is configured to group terminal devices of the viewer, wherein the at least one processor that is configured to:
insert advertisement content into the content for each of groups of the terminal devices; and
transmit the content for each of the groups of the terminal devices.

17. The broadcast system according to claim 10, wherein the broadcast system is disposed in a virtual environment on a cloud.

18. An advertisement allocation generation method comprising:
acquiring viewing-related data of a viewer from a terminal device with which the viewer views content;
acquiring advertisement allocation condition data for allocating advertisement content to a program; and
generating, based on the viewing-related data and the advertisement allocation condition data, advertisement allocation information obtained by allocating the advertisement content to a program of content to be broadcast to the viewer.

19. (canceled)
